(19) United States
(12) Patent Application Publication
(10) Pub. No.: US 2024/0095842 A1
(43) Pub. Date: Mar. 21, 2024

(54) PREMIUM ADJUSTMENT AND RISK MANAGEMENT

(71) Applicant: NextCar Holding Company, Inc., Santa Monica, CA (US)

(72) Inventors: Scott Painter, Bel Air, CA (US); James Thai Nguyen, Palos Verdes Estates, CA (US); Chris Andrews, Palos Verdes Estates (CA)

(21) Appl. No.: 18/472,153

(22) Filed: Sep. 21, 2023

Related U.S. Application Data
(60) Provisional application No. 63/408,759, filed on Sep. 21, 2022.

(51) Int. Cl. G06Q 40/08; G07C 5/00

(52) U.S. Cl. CPC G06Q 40/08; G07C 5/008

(57) ABSTRACT

Systems and methods for adjusting insurance premiums are provided. Embodiments provide systems and methods for providing a time-based adjustment to insurance premiums, as well as premium adjustment, and risk management. Some embodiments use collected data, such as telematics to take in data and determine, on a periodic basis, when a vehicle is actually moving and when it is not. In some embodiments, an insurance policy can be adjusted in real-time based on driving behaviors or restrictions. In some embodiments, an insurance policy can be adjusted in real-time to accommodate multi-driver situations

### CROSS-REFERENCE TO RELATED APPLICATION(S)

This application claims a benefit of priority under 35 U.S.C. § 119(e) from U.S. Provisional Application No. 63/408,759, filed Sep. 21, 2022, entitled “PREMIUM ADJUSTMENT AND RISK MANAGEMENT,” which is fully incorporated by reference herein for all purposes.

### TECHNICAL FIELD

This disclosure relates generally to vehicle insurance. In particular, this disclosure

relates to systems and methods for providing time-based adjustments to insurance premiums.

### BACKGROUND

Vehicle insurance for cars, trucks, motorcycles, etc., provides financial protection against

physical damage or bodily injury resulting from traffic collisions and against liability that could also arise from incidents in a vehicle. Vehicle insurance may additionally offer financial protection against theft of the vehicle, and against damage to the vehicle sustained from events other than traffic collisions. Typically, insurance premiums are determined by an insurance company, which can vary depending on many factors that are believed to affect the expected cost of future claims, such as the car characteristics, the coverage selected (deductible, limit, etc.), the profile of the driver(s), and the usage of the vehicle (commute to work or not, predicted annual distance driven, etc.).

A typical insurance policy involves charging a premium for coverage over a set time

period (e.g., 6 months, 12 months, etc.). Currently, the insurance industry has a concept of “pausing” your coverage when your vehicle is not being used (e.g., used with RVs in particular). Namely, when you park your RV and aren't driving it, you can call the insurance company and they will “pause” your premiums. In the insurance industry, there is also the idea of “distance-based” adjustments to premiums — in other words, if you don't drive as far as someone else, you might get a rebate or discount.

### SUMMARY

Systems and methods are described for adjusting insurance premiums that involve

collecting telematics data associated with a vehicle for a given time period, determining, based on the telematics data, when the vehicle is moving and when the vehicle is stationary during the given time period, and adjusting an insurance premium for the vehicle based on the determination when the vehicle is moving and when the vehicle is stationary during the given time period.

Embodiments of the present invention also include computer-readable storage media

containing sets of instructions to cause one or more processors to perform collecting telematics data associated with a vehicle for a given time period, determining, based on the telematics data, when the vehicle is moving and when the vehicle is stationary during the given time period, and adjusting an insurance premium for the vehicle based on the determination when the vehicle is moving and when the vehicle is stationary during the given time period.

Embodiments of the present invention also describe systems and methods for adjusting, in real-time, an insurance premium for a vehicle associated with a user including collecting real-time telematics data associated with the vehicle for a given time period, adjusting the insurance premium for the vehicle based on driving behaviors determined based on the collected real-time telematics, and notifying the user of the insurance premium adjustment.

Embodiments of the present invention also describe systems and methods for adjusting, in real-time, a premium for an insurance policy for a vehicle associated with a first user, including requesting an image of a drivers license of a second user, obtaining one or more reports relating to potential risk associated with the second user, and calculating an adjustment to the premium of the insurance policy based on the obtaining one or more reports relating to potential risk associated with adding the second user to the insurance policy.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict

certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a flowchart depicting an exemplary process for adjusting an insurance premium

based on vehicle user and non-use.

FIG. 2 is a flowchart depicting an exemplary process for adjusting an insurance premium

based on vehicle user and non-use, including verification based on user input.

### DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Generally, the present disclosure describes a system and method for providing a “time-based” adjustment to insurance premiums, as well as premium adjustment, and risk management. Some embodiments use collected data, such as telematics (e.g., from Tesla or other computer linked automobiles via an application programming interface (API), a third party dongle, from using the sensors and location data built into a mobile phone, mobile applications, etc.) to take in data and figure out, on a periodic basis (e.g., daily, hourly, etc.), when a vehicle is actually moving and when it is not. In one embodiment, telematics are gathered from the vehicle and from the user (via an application on the user's phone). When the vehicle is moving, the system figures out a premium for that time, then adjusts that premium (i.e., reduces it or gives a rebate or credit, eliminates completely, etc.) based on the time that the vehicle is not moving. In other words, some embodiments provide an “automated” “real-time” “time-based” adjustment to car insurance premiums based on how long in an “x” period (month, week, day, hour, etc.) the car was actually moving (i.e., how long the car was actually being driven).

The determination of when a car is being driven or not can be based on various sources of data, as one skilled in the art would understand. In some embodiments, the determination can be based on when a customer informs the insurance company that the car is being used, which can be automatically verified based on the various sources of data. For example, a driver may inform the insurance company that the car will be used to commute to work from 7:30 AM-8:00 AM and 5:30 PM-6:00 PM. The policy premium can be based on the driver's input, but the actual usage of the car can be automatically verified using other collected data.

Generally, data (i.e., GPS, Accelerometer, odometer, user input, etc.) is collected (e.g., via vehicle and/or application telematics) and analyzed to determine whether a car is in use (“moving”) or not in use (“parked”) for a particular time period. The determination of movement of a vehicle can be based on numerous sources of data and combinations thereof, for example:
Location—e.g., provided by a Global Positioning System (GPS) system of a car or phone (e.g., via a Bluetooth connection). Typical accuracy may be within 5 meters, so a 5 meter threshold may be used to detect movement of the car.
Acceleration—e.g., provided by the accelerometer of a phone or car, GPS, etc. As an example, acceleration to above 25 mph could be interpreted as the start of a trip, and 5 mins of no movement could be interpreted as the end of a trip). Note that, in the example of accelerometer data collected from a user's phone, it is important to determine that detected acceleration results from acceleration from the car in question, versus another car, for example. In one example, data from another source can be used to verify that the detected acceleration is the acceleration of the car in question. In another example, the car in question can be tied to the policy using the Bluetooth signal of the car. For example, the mobile application can watch for the Bluetooth signal from the vehicle (a Bluetooth connection would not be required) to make a determination that the user is in the proximity of car in question.
Tire rotation—e.g., provided by a vehicle odometer (typically with 0.5 inch accuracy).
Change of surroundings—e.g., based on picture(s) or video(s) of a vehicle odometer (using Optical Characgter Recognition to read the numbers on the odometer) with windshield in view.
User Input—e.g., a user specifies that a car hasn't moved, or has started/stopped (in combination real-time verification, in some embodiments). Verification can be based on various sources of data, including picture of the car dash, etc.
Telematics—e.g., provided by a computer linked vehicle, etc. or a user's mobile phone. In some embodiments, telematics can be periodically polled from a vehicle (or mobile app) over time (e.g., every X seconds or minutes). Telematics data can comprise any data relating to a vehicle or the vehicle's operation, including the various data sources listed herein.
Car door sensors and/or seat sensors—provided as indicators that a vehicle may be in use by a driver. Note that car door and seat sensors may also be used to detect the use of a vehicle ride-share usage, which may be prohibited by a given insurance policy.
Cameras—e.g., image and/or video data from various cameras (dash cameras, backup cameras, parking assist cameras, interior facing cameras, etc.) can provide an indication that a vehicle may be in use.
Facial recognition—e.g., image and/or video data from one or more cameras (or a selfie taken by the user) can provide an indication that a vehicle may be in use by the insured driver, or another driver.
Status of door locks—e.g., the car doors remaining locked during the period in question provide information with respect to activities of a driver and thus car movement/non-movement.
Battery/Fuel status—e.g., no abnormal change in charge state can provide an indication of car movement/non-movement. Similarly, if the vehicle data indicates that the vehicle is charging, the vehicle is parked. If the vehicle data indicates that the vehicle is discharging, the vehicle could be moving, although there are numerous ways that the battery could discharge while parked.
Engine status—e.g., whether the car engine was started or not provides an indication of car movement/non-movement.
Gear status—e.g., a vehicle that was never taken out of park provides an indication of non-movement.

One potential challenge with using telematics from a vehicle or mobile application relates to connectivity. For example, if the vehicle or mobile phone do not have a data connection, the system will still need to make the determinations discussed above. In some embodiments, the mobile application can continue to collect data (e.g., location information, acceleration, etc., even while offline, and then update the system once a data connection is available.

Another challenge relates to a user having their phone turned off, or location services disabled. In some embodiments, terms of service requirements can try to address this issue by requiring users to agree to turn on location services while using the vehicle in question. If the system determines that a user is not complying with the terms of service (or other desired phone configurations), a notification can be sent to the user to turn on location services, for example.

Once data is available to the system, the system can make determinations of whether a vehicle is in use (i.e., being driven) or is not in use (i.e., being parked). As discussed any combination of data discussed above can be used to make these determinations. In one simple example, a system may provide maps showing a vehicle's location, for example, from the GPS of the vehicle. In such example, simply monitoring the map by the system can determine if the vehicle is moving or not. These determinations can be made is real-time or near real-time.

One technical problem with making these determinations is getting an accurate determination. As the list of exemplary data sources shows, a determination can be based on numerous sources of data. It is challenging to figure out which combinations of data sources will result in accurate results. Each single data source may not be able to provide an answer itself. In addition, as indicated above, various data sources have inherent problems that should be addressed to get an accurate determination.

Other technical problems with detecting movement of a vehicle involve validating that sensor values are accurate and minimizing false positives and false negatives. Some techniques that could be used to solve these problems involve simple voting schemes (e.g., using 2 out of 3 inputs to confirm movement/non-movement) to complicated data science techniques including training a Quantile Regression Neural Network. In some embodiments, examples of inputs could include comparing telematics data from the vehicle to telematics data from sensors on a mobile phone (and vice versa). Validating the accuracy of data will improve the reliability of detecting vehicle movement.

A system can use the collected data to make determinations in many different ways, as one skilled in the art would understand. For example, to make the determination that a vehicle is being driven, the system may use thresholds to change the determined stats from “parked” to “in use”, and vice versa. For example, a system may determine a vehicle is “in use” when the vehicle accelerates to, for example, 25 mph. Similarly, the system may determine the vehicle is “not in use” when the vehicle in not in motion for some time period (e.g., 5 minutes).

In some embodiments, determinations can be cross-verified, e.g., using GPS data and accelerometer data, etc., to actually determine that for X period of time, the car was “moving” for Y period of time during X. Generally, data from an odometer may be the most accurate, then data from a car GPS, then data from a phone GPS, then accelerometer data (from a car or phone). Also note that, gear state may also be accurate, i.e., if a vehicle never leaves park, then it could not have moved on its own, but perhaps could have been towed. In some examples, the system will prefer to use the most accurate data, and if the top source isn't available, the system defaults to the next data source, etc. The system can also detect various other exception scenarios such as a car being towed. For example, if the car doors remain locked, the gear state is in park, etc., yet the car is moving, this could indicate that the car is being (or has been) towed, stolen, etc.

As described above, a system provides a “time-based” adjustment to insurance premiums using determinations based on collected data. Following is one example of how insurance premiums can be adjusted based on the usage determinations described above. Many other examples are also possible, as one skilled in the art would understand. In a first example, Driver A′s insurance premium gets adjusted based on the usage determination (“in use” or “not in use”) described above as to how much the driver's car was “parked” versus “moving” during the time period. For example, if Driver A pays $/month premium and car “moves” Y time during X period of time, the system can determine what benefit/detriment Driver A actually gets based on the usage determinations. In some examples, a driver can be charged based on vehicle usage and/or driving patterns. Following are several examples of possible implementations of premium adjustments. Numerous other examples are also possible, as one skilled in the art would understand.
Driver A pays a $6 premium per day, for days that the car is driven. For example, for every 24 hour period that Driver A′s vehicle moves, the insurance company charges $6.
Driver A pays a $200 premium per month. For every 24 hour period that Driver A′s vehicle does not move, the insurance company reduces the next month's premium by $3.
Driver B pays a $200 monthly premium for 100 hours of driving. For every full hour that the vehicle does not move below 50 hours, the insurance company reduces the next month's premium by $1.
Driver C pays $2 per hour driven for insurance. Note that an “hour” driven could mean any usage during an hour time period, or a could mean an hour of actual driving (e.g., 30 minutes during a first drive and 30 minutes during a second drive). Other examples are also possible.
Driver D pays for insurance (e.g., using one of the examples above), but adjustments are made based on vehicle usage or driving patterns. For example, an extra charge (or discounts) could be incurred for driving during certain hours of the day, driving in certain locations, commuting versus other driving, using certain driving patters (excessive speeds, breaking patterns, etc.).

While a system providing time-based adjustment to insurance premiums can be implemented in any desired manner, several considerations can be taken into account. For example, the system may allow changing levels of coverage. In one example, such a change must be made before midnight of that day. In another example, the system may allow changing levels of deductibles. In one example, such a change must be made before midnight of that day. An insurance company providing insurance policies with time-based adjustment to insurance premiums may bundle charges and charge a user's credit card, bank account or wallet on a weekly basis, for example. In some embodiments, a driver must “sideline” a vehicle before they won't get charged vs. automatically detecting movement and charge for that day (proactive vs. reactive charging). For the purposes of this description, “sideline” may refer to the ability to pre-pause insurance on a vehicle for a specified duration. In some embodiments, the time of day that a car is in use can be taken into consideration. For example, usage at 2AM could trigger a higher premium than usage at 10 AM.

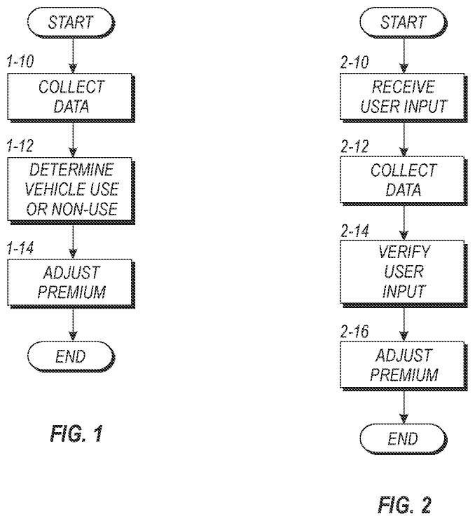

FIGS. 1 and 2 are flow charts depicting exemplary processes described above. In the process of FIG. 1, data is collected at step 1-10. The collected data can be any data (such as the examples listed above) that provides some indication of vehicle use or movement. At step 1-12, the data is analyzed to make a determination (described above) that the vehicle is in use (e.g., being driven) or not in use (e.g., parked). As described above, the determination can be made from any data source, or combination of data sources. Based on the determination from step 1-12, the insurance premium is adjusted according at step 1-14, as described above.

In the process of FIG. 2, user input is received at step 2-10. The user input provides an indication by a driver when the car is in use, for example, for a commute. At step 2-12, data is collected, which can be any data (such as the examples listed above) that provides some indication of vehicle use or movement. At step 2-14, the data is analyzed to verify the user input that the vehicle was in use (e.g., being driven) or not in use (e.g., parked) when specified. Based on the determination from step 2-14, the insurance premium is adjusted according at step 2-16, as described above.

As mentioned above, the present disclosure also describes a system and method for facilitating premium adjustment and managing risk. Policies can be adjusted (in real-time or after the fact) based on information about a customer (e.g., time of day, type of vehicle, operator of a vehicle, change in customer information (e.g., age), the number of insureds, etc.).

Generally, various information can be collected to be used in determining premium rates. Note that this collected information may be collected for various reasons, such as during a customer sign-up, insurance inquiries, etc. Collected information may include, for example: age of a driver (e.g., from a drivers license (DL), etc.), FICO score, DMV reports, CLUE (comprehensive loss underwriting exchange) reports, garage address, vehicle value, miles driven (e.g., X miles per month), background checks, etc. In some examples, the validity of a DL can be confirmed from a respective state agency or other service. In some examples, the provider of the DL can also be confirmed to be the license holder. For example, a system can request a selfie from the user, and the system can determine (manually, via artificial intelligence (Al), etc.) from a comparison of the selfie and the picture on the DL that the user is the actual license holder. The information associated with the user that is collected can be used for purposes such as qualifying a customer for a vehicle, qualifying the customer for insurance, setting insurance rates, etc.

Insurance rates for a given user and vehicle can be calculated in any desired manner, as one skilled in the art would understand. For example, rates can be based on rating tables and various factors. The various factors used to determine risk, rates, etc., can be weighted and used together to determine insurance rates. For example, an algorithm can be used to calculate a score based on various weighted factors. In other examples, machine learning (ML) models can be used for calculating scores. Using application on the user's phone, information can be collected (along with any reports collected) and used to determine rates for a user. The application can also be used to provide feedback to the user, such as an insurance quote or an approval/rejection notification. In addition, the application can provide the user with other feedback, such as asking for more information, asking to link a bank account, asking for clarifications, etc.

In some examples, telematics from an app can provide real-time factors (e.g.,

acceleration, speeding, hard braking, cornering, phone use, etc.) that can be used for adjusting ratings (and thus premiums, etc.). Such factors could also be used to end coverage (e.g., if a driver violates agreed upon parameters, etc.).

In one example, the invention is helpful to perform a risk analysis in order to adjust insurance premiums on cars in a multi-driver situation. For instance, if you have a multi-driver situation (e.g., multiple drivers in a single household), the invention can calculate risk associated with having the insured car being driven by multiple individuals, and then using that risk modeling, can meld that into a single policy (i.e., single premium). This can be applied to any multi-driver situation, and even a move from single driver to multi-driver. In one example, if you have a single driver situation, but you need to permanently add a new driver (e.g., a child reaches driving age), the policy can be updated in real time for the new multi-driver situation. In another example, if you have a single driver situation, but you temporarily need to add a driver (e.g., due to a visitor visiting from out of town), the policy can be updated in real time for the new multi-driver situation. In some examples, this can be done from taking a simple a screen shot of the driver's license (DL) of the new driver, using various data capture and analytics in the background, and calculating an adjustment (up or down) of the premium, to let the additional driver drive the car. Other types of information may also be collected, such as CLUE reports, garage address, mileage driven, vehicle value, a selfie of a new driver (e.g., to match the DL information), address, etc. Basically, it can be used as a “real-time” adjustment to the underwriting risk of insuring additional drivers, and adjusting the premium accordingly (again, in real time or near real time, in some examples).

Following is an example where a new driver (permanently or for a short term) is added to a policy, and how the insurance policy gets adjusted once the risk factors are analyzed. In this example, we are trying to either (1) add a new driver permanently to the policy (e.g., a child reaches driving age), or (2) add a new driver for a short term (e.g., a visitor visits for a week). In some embodiments, new driver risk factors are collected, for example, via manually entry, texted link, or in an application, based on a phone number and driver's license. Additional information can be pulled, such as FICO, motor vehicle records (MVR), CLUE reports, age, vehicle information associated with the current policy holder, garaging address of the current policy holder, and average miles driven per day (adjusted for weekends), to assess risk.

In some embodiments, the insurance policy can be adjusted daily based on items such as risk level (e.g., high/medium/low risk), coverage levels (e.g., collision, comprehensive, medical, roadside assistance, liability levels, etc.), and a deductible amount. A daily rate is then set based on the coverage levels present at the beginning of the day. Table 1 shows a simplified example of insurance premiums (a daily rate) over several levels of risk for several different coverage levels. Table 1 shows three different insurance policies (e.g., policies with different coverage levels and/or coverage types) and three different risk levels (low, medium, high), and a corresponding daily insurance rate, which takes into account the factors that are normally considered when determining insurance rates. Table 1 shows an example for a given deductible amount. For higher and lower deductible amounts, the corresponding rates would be lower or higher, as one skilled in the art would understand.

TABLE 1

| | Policy A | Policy B | Policy C |
|---|---|---|---|
| High | $10 | $12 | $20 |
| Medium | $7 | $9 | $15 |
| Low | $5 | $7 | $10 |

In some embodiments, an insurance policy can be adjusted (e.g., daily) based on driving behaviors (hours of the day, locations, speed or other driving characteristics, etc.) or restrictions (hours, miles, etc.). While a premium can be set/adjusted based on mileage, hours, etc., premiums can also be adjusted based on undesirable driving behaviors. For example, if a driver has a DUI history, a policy can be based on that user only driving during certain hours of the day, for example. If the driver drives during a prohibited time (e.g., late night), the premium can be adjusted upward accordingly, or the policy canceled. When adjusted, the user can be notified via the mobile application, or in another manner. Similarly, the policy of a driver with a history of speeding tickets can be adjusted upward (or canceled) based on exceeding speed limits or guidelines. In other examples, a policy premium can be based on driving a certain number of miles or driving at certain times of day. For example, a premium can be adjusted when such a driver drives at night, or outside of their specified time periods. In another example a policy premium can be based on specific situations (e.g., commuting to/from work), with the premium being adjusted if the driver deviates from the specified situations. In some embodiments, when a driver deviates from such behaviors or restrictions, the driver can be notified (e.g., via the mobile application) that they are deviating from their specific plan. The system could give the drive a chance to get the vehicle back with the policy requirements, or could automatically add a surcharge or premium adjustment.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of adjusting, in real-time, an insurance premium for a vehicle associated with a user, the method comprising:
collecting real-time telematics data associated with the vehicle for a given time period;
adjusting the insurance premium for the vehicle based on driving behaviors determined based on the collected real-time telematics; and
notifying the user of the insurance premium adjustment.

2. The method of claim 1, wherein the collected telematics data comprises data collected from a vehicle.

3. The method of claim 2, wherein the collected telematics data comprises data collected from an application installed on a mobile phone.

4. The method of claim 1, wherein the collected telematics data includes location data.

5. The method of claim 4, wherein the location data includes GPS data.

6. The method of claim 1, wherein the collected telematics data includes acceleration data.

7. The method of claim 1, wherein the insurance premium is adjusted based on the time of day that the vehicle is used.

8. The method of claim 1, wherein the insurance premium is adjusted based on driving behaviors determined based on the collected real-time telematics data.

9. A system for providing adjusting, in real-time, an insurance premium for a vehicle, the system comprising:
a processor; and
a non-transitory computer readable medium storing instructions translatable by the processor, the instructions when translated by the processor perform:
collecting real-time telematics data associated with the vehicle for a given time period;
adjusting the insurance premium for the vehicle based on driving behaviors determined based on the collected real-time telematics; and
notifying the user of the insurance premium adjustment.

10. The system of claim 9, wherein the collected telematics data comprises data collected from a vehicle.

11. The system of claim 10, wherein the collected telematics data comprises data collected from an application installed on a mobile phone.

12. The system of claim 9, wherein the collected telematics data includes location data.

13. The system of claim 12, wherein the location data includes GPS data.

14. The system of claim 9, wherein the collected telematics data includes acceleration data.

15. The system of claim 9, wherein the insurance premium is adjusted based on the time of day that the vehicle is used.

16. The system of claim 9, wherein the insurance premium is adjusted based on driving behaviors determined based on the collected real-time telematics data.

17. A method of adjusting, in real-time, a premium for an insurance policy for a vehicle associated with a first user, the method comprising:
requesting an image of a drivers license of a second user;
obtaining one or more reports relating to potential risk associated with the second user; and
calculating an adjustment to the premium of the insurance policy based on the obtaining one or more reports relating to potential risk associated with adding the second user to the insurance policy.

18. The method of claim 17, further comprising adding the second user to the insurance policy on a temporary basis.

19. The method of claim 17, further comprising adding the second user to the insurance policy on a permanent basis.

20. The method of claim 17, wherein the one or more reports relating to potential risk associated with the second user include driving records of the second user.
